(19) United States
(12) Patent Application Publication
(10) Pub. No.: US 2024/0130005 A1
(43) Pub. Date: Apr. 18, 2024

(54) System for Heating a Process Medium and Method of Control

(71) Applicant: Chromalox, Inc., Pittsburgh, PA (US)

(72) Inventors: Richard TRUSSLER, Pittsburgh, PA (US); Mark WHEELER, Pittsburgh, PA (US)

(21) Appl. No.: 17/964,251

(22) Filed: Oct. 12, 2022

(51) Int. Cl. H05B 1/02

(52) U.S. Cl. CPC H05B 1/0202

(57) ABSTRACT

The present disclosure relates to a method 200 of controlling a system 100, 100′, 100″ including a heating arrangement 130 for heating a process medium 140, a current sensing arrangement 180, and a switching arrangement 120 configured to selectively couple a power supply 110 to the heating arrangement, the switching arrangement comprising at least one semiconductor switch 120A, 120B, 120C. The method 200 comprises: in response to a demand signal 224 for starting heating of the process medium 140, operating 204 the system in a test mode 230. Operating the system in the test mode 230 includes performing a test sequence 230A. The test sequence 230A comprises: controlling 232A the switching arrangement 120 to couple the power supply 110 to the heating arrangement 130 for a predetermined period; monitoring 234A an electric current through the heating arrangement 130 during the predetermined period using the current sensing arrangement 180; comparing 236A the monitored electric current to an electric current threshold during the predetermined period; and switching 206 the system from operation in the test mode 230 to operation in a dormant mode 210, 220 if the monitored electric current meets or exceeds the electric current threshold during the predetermined period. Operation of the system in the dormant mode 210, 220 includes controlling 212, 222 the switching arrangement 120 to decouple the power supply 110 from the heating arrangement 130.

### FIELD OF THE INVENTION

The present disclosure relates to a system including a heating arrangement for heating a process medium. It relates further to a method of controlling a system including a heating arrangement for heating a process medium.

### BACKGROUND TO THE INVENTION

In industrial processes, it may be necessary to heat a process medium such as oil, gas or another process fluid, or a solid process medium. In particular, heating of the process medium may be to achieve a target temperature, and/or to maintain the process medium at the target temperature. In such industrial processes a system including an electric heating arrangement may be used for heating the process medium. In particular, the process medium to be heated may be a process fluid.

In use, faults may develop within the system which are associated with a risk of damage to the system itself and/or unintended conduction of electric current to components outside of the system. For instance, faults may arise within the electric heating arrangement of such a system due to failure of a sealing structure around the heating arrangement and, in particular, due to process fluid ingress into the heating arrangement. Damage to the system may occur as a result of thermal damage within the heating arrangement, such as melting of a heating element within the heating arrangement. Unintended conduction of electrical current to components outside of the system may occur as a result of conduction of electric current from the heating arrangement to the components outside of the system through the process medium. Unintended conduction of electrical current to components outside of the system may occur as a result of conduction of electric current from the conductors to the heater through the conductor insulation.

It is desirable to provide a system and a method for heating a process medium which enables the provision of improved safeguards against the risks associated with the development of faults within a heating arrangement of the system.

### SUMMARY OF THE INVENTION

According to a first aspect there is provided a method of controlling a system including a heating arrangement for heating a process medium, a current sensing arrangement, and a switching arrangement configured to selectively couple a power supply to the heating arrangement, the switching arrangement comprising at least one semiconductor switch, the method comprising:
in response to a demand signal for starting heating of the process medium, operating the system in a test mode, wherein operating the system in the test mode includes performing a test sequence comprising:
   controlling the switching arrangement to couple the power supply to the heating arrangement for a predetermined period;
   monitoring an electric current through the heating arrangement during the predetermined period using the current sensing arrangement;
   comparing the monitored electric current to an electric current threshold during the predetermined period; and
   switching the system from operation in the test mode to operation in a dormant mode if the monitored electric current meets or exceeds the electric current threshold during the predetermined period, wherein:
operation of the system in the dormant mode includes controlling the switching arrangement to decouple the power supply from the heating arrangement.

It may be that performing the test sequence further comprises switching the system from operation in the test mode to operation in a heating mode if the monitored electric current does not meet the current threshold during the predetermined period. Operation of the system in the heating mode includes controlling the switching arrangement to couple the power supply to the heating arrangement for heating the process medium.

Operation of the system in the heating mode may include, in response to a terminate signal for ending heating of the process medium, switching the system from operation in the heating mode to operation in the dormant mode.

It may be that, when coupled to the heating arrangement, the power supply provides a periodic AC electrical power to the heating arrangement. A duration of the predetermined period may be no greater than 25% of a duration of a characteristic time period of the periodic AC electrical power. The duration of the characteristic time period of the periodic AC electrical power may be no greater than 20 milliseconds.

Additionally or alternatively, it may be that the predetermined period is defined according to a phase angle range of the periodic AC electrical power, the phase angle range being defined between a first phase angle of the periodic AC electrical power and a second phase angle of the periodic AC electrical power. It may also be that the second phase angle of the periodic AC electrical power is between: 10 degrees less than a zero-crossing phase angle of the alternating current electrical power; and the zero-crossing phase angle of the alternating current electrical power. The first phase angle of the AC electrical power may be between 1 and 20 degrees less than the second phase angle of the AC electrical power.

Further, it may be that:
the test sequence is a final test sequence, the electric current threshold is a final electric current threshold and the predetermined period is a final predetermined period;
operation of system in the test mode includes performing a preliminary test sequence preceding the final test sequence; and
performing the preliminary test sequence comprises:
   controlling the switching arrangement to couple the power supply to the heating arrangement for a preliminary predetermined period;
   monitoring an electric current passing through the heating arrangement during the preliminary predetermined period using the current sensing arrangement;
   comparing the monitored electric current to a preliminary electric current threshold during the preliminary predetermined period,
   switching the system from performing the preliminary test sequence to the final test sequence if the monitored electric current does not meet the preliminary current threshold during the preliminary predetermined period, and
   switching the system from operation in the test mode to operation in the dormant mode if the monitored electric current meets or exceeds the preliminary electric current threshold during the preliminary predetermined period.

A duration of the final predetermined period may be greater than a duration of the preliminary predetermined period. It may be that each of the final predetermined period and the preliminary predetermined period is defined according to a phase angle range of the periodic AC electrical power, each phase angle range being defined between a first phase angle of the periodic AC electrical power and a second phase angle of the periodic AC electrical power, and it may be that the first phase angle which defines the preliminary predetermined period is closer to the zero-crossing phase angle of the periodic AC electrical power than the first phase angle which defines the final predetermined period.

It may be that, when coupled to the heating arrangement, the power supply provides a DC electrical power to the heating arrangement, and wherein the system comprises a DC-DC converter, and it may also be that performing the test sequence includes controlling the DC-DC converter to ensure that a magnitude of a DC current of the DC electrical power provided to the heating arrangement is less than a rated current of the switching arrangement throughout the predetermined period.

In addition, it may be that performing the preliminary test sequence includes controlling the DC-DC converter to ensure that a magnitude of a DC current of the DC electrical power provided to the heating arrangement is less than a rated current of the switching arrangement throughout the preliminary predetermined period. It may also be that the magnitude of the DC current through the heating arrangement throughout the preliminary predetermined period is less than the magnitude of the DC current through the heating arrangement throughout the final predetermined period. The DC-DC converter may include a chopper.

It may also be that:
operation of the system in the test mode includes switching the system from operation in the test mode to operation of the system in a first dormant mode if the monitored electric current meets or exceeds the electric current threshold during the predetermined period,
operation of the system in the first dormant mode includes:
   controlling the switching arrangement to decouple the power supply from the heating arrangement;
   in response to the demand signal for starting heating of the process medium, continuing to operate the system in the first dormant mode; and
   in response to a reset signal, switching the system from operation in the first dormant mode to operation in a second dormant mode, and operation of the system in the second dormant mode includes:
   controlling the switching arrangement to decouple the power supply from the heating arrangement;
   in response to the demand signal for starting heating of the process medium, switching the system from the second dormant mode to the test mode.

Operation of the system in the first dormant mode may include generating an alarm indicative of a fault associated with the heating arrangement.

Additionally, it may be that, when coupled to the heating arrangement, the power supply provides a polyphase periodic AC electrical power to the heating arrangement, and wherein the heating arrangement comprises a plurality of heating elements, each heating element being configured to receive a respective phase of the polyphase periodic AC electrical power from the power supply via the switching arrangement.

According to a second aspect there is provided a data processing apparatus comprising a controller adapted to perform the method of the first aspect.

According to a third aspect there is provided a system comprising: a heating arrangement for heating a process medium; a switching arrangement configured to selectively couple a power supply to the heating arrangement, the switching arrangement comprising at least one semiconductor switch; a current sensing arrangement; and a controller configured to control the system in accordance with the method of the first aspect.

The at least one semiconductor switch may be a transistor or a thyristor. The at least one semiconductor switch may be selected from a group consisting of: a field-effect transistor, a gate turn-off thyristor, integrated-gate bipolar transistor, an integrated gate-commutated thyristor, and an injection-enhanced gate transistor.

According to a fourth aspect there is provided a machine-readable storage medium having stored thereon instructions which, when executed by a controller, cause the controller to carry out the method of the first aspect.

### BRIEF DESCRIPTION OF THE DRAWINGS

FIG. 1A shows, schematically, a first example system:

FIG. 1B shows, schematically, a second example system;

FIG. 1C shows, schematically, a third example system;

FIG. 2A is a flowchart which shows an example method of controlling a system;

FIG. 2B is a flowchart showing an example second dormant mode of the method shown in FIG. 2A in detail;

FIG. 2C is a flowchart showing an example test mode of the method shown in FIG. 2A in detail;

FIG. 2D is a flowchart showing an example preliminary test sequence of the test mode shown in FIG. 2C in detail;

FIG. 2E is a flowchart showing an example final test sequence of the test mode shown in FIG. 2C in detail;

FIG. 2F is a flowchart showing an example locked dormant mode of the method shown in FIG. 2A in detail;

FIG. 2G is a flowchart showing an example heating mode of the method shown in FIG. 2A in detail;

FIG. 3 is an annotated graph which shows a profile of a supply of alternating current electrical power;

FIG. 4A is a highly schematic diagram of a data processing apparatus comprising a controller; and

FIG. 4B shows, symbolically, a machine-readable medium having stored thereon a software program which, when executed by a controller, causes the controller to perform the method of FIG. 2A.

### DETAILED DESCRIPTION

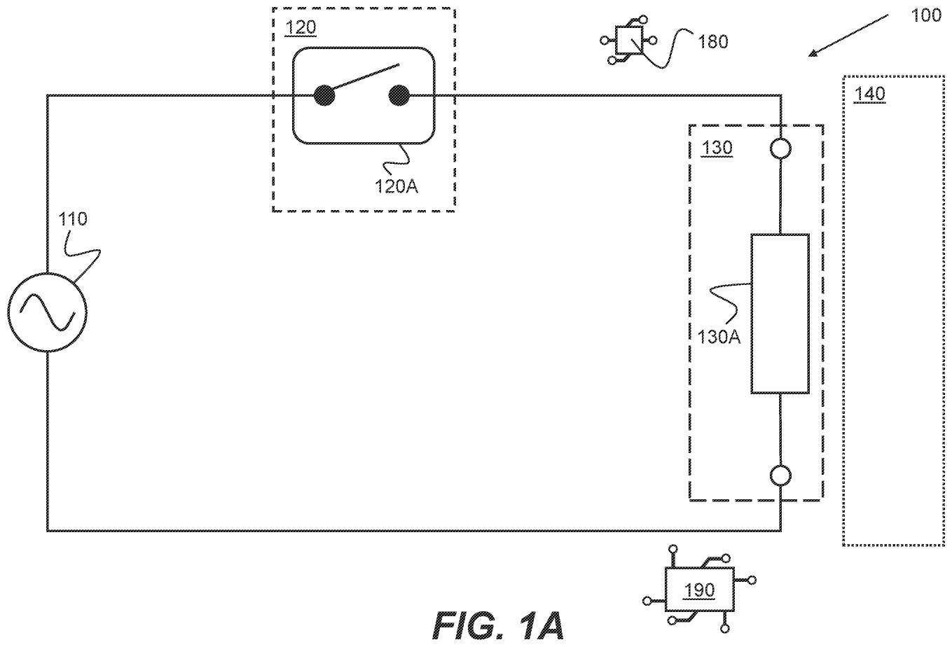

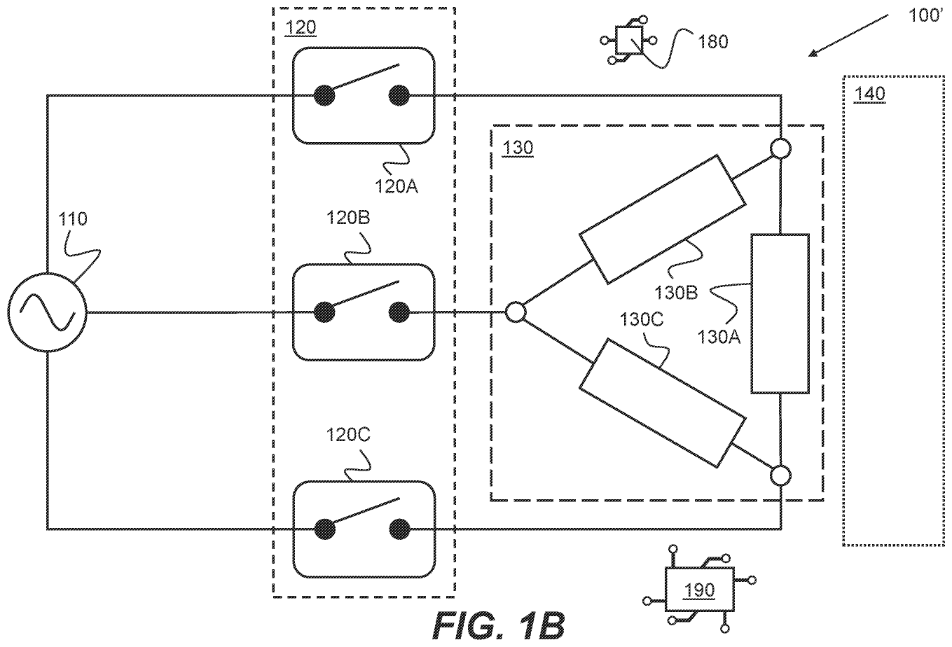

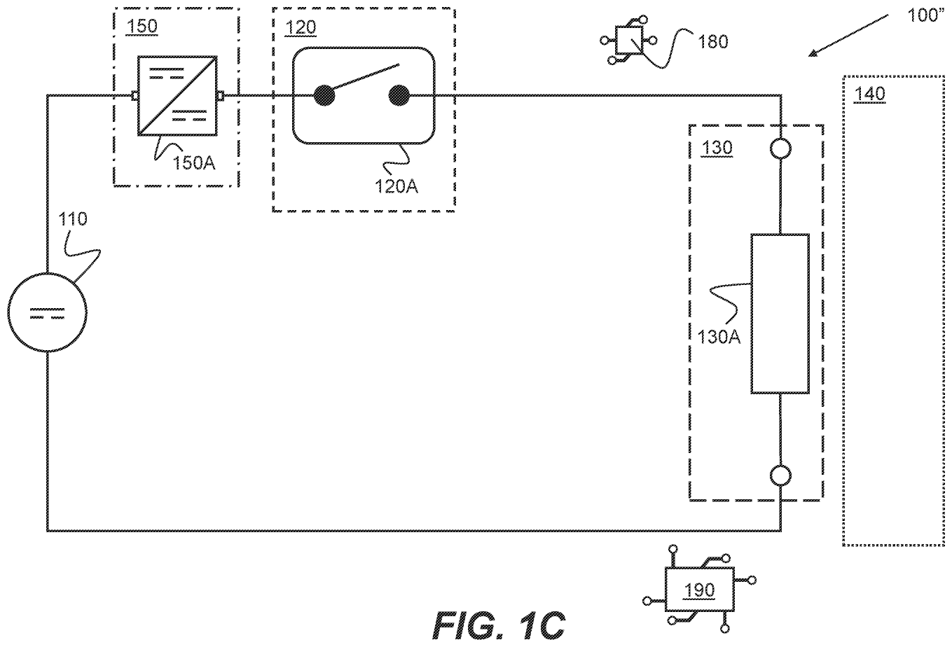

FIG. 1A shows a first example system 100 comprising a switching arrangement 120, a heating arrangement 130 for heating a process medium 140, a current sensing arrangement 180 and a controller 190. FIG. 1B shows a second example system 100′ which is generally similar to the first example system 100, with like reference signs indicating common or similar features. FIG. 1C shows a third example system 100″ which is generally similar to the first example system 100, with like reference signs indicating common or similar features. The differences between each of the first example system 100, the second example system 100′ and the third example system 100″ are explained in detail below.

The switching arrangement 120 is generally configured to selectively couple a power supply 110 to the heating arrangement 130. When the power supply 110 is coupled to the heating arrangement 130 by the switching arrangement 120, the power supply 110 provides electrical power to the heating arrangement 130 for heating the process medium 140. The heating arrangement 130 is configured to convert electrical power supplied from the power supply 110 via the switching arrangement 120 into heat by means of an Ohmic heating process within a heating element of the heating arrangement 130. Heat is then transferred to the process medium 140 as a result of conduction, convection and/or radiation, as will be appreciated by those skilled in the art. When the power supply 110 is decoupled from (e.g. isolated from) the heating arrangement 130 by the switching arrangement 120, the power supply 110 does not provide electrical power to the heating arrangement 130.

To selectively couple the power supply 110 to the heating arrangement 130, the switching arrangement 120 comprises at least one semiconductor switch. Conventional switches (e.g. mechanical or other non-semiconductor switches) may generally have a higher rated current than the semiconductor switches of the example systems of the present disclosure. In use, the heating arrangement 130 may generally require the supply of a relatively large electric current to adequately heat the process medium 130. Consequently, existing systems typically make use of non-semiconductor switches for the purpose of selectively coupling and/or decoupling a power supply to a heating arrangement. However, use of at least one semiconductor switch 120A within the switching arrangement 120 enables selective coupling and/or decoupling of the power supply 110 and the heating arrangement 130 to be executed more rapidly compared to non-semiconductor switches.

To this end, the at least one semiconductor switch 120A-120C may be, for example, a transistor or a thyristor. In particular, the or each semiconductor switch may be a field-effect transistor, a gate turn-off thyristor, integrated-gate bipolar transistor, an integrated gate-commutated thyristor, and/or an injection-enhanced gate transistor. Use of such types of semiconductor switches as a part of the switching arrangement 120 may provide more robust means for selectively coupling and/or decoupling the power supply 110 from the heating arrangement 130, which is associated with an extended lifetime of the system 100, 100′, 100″.

In both the first example electrical system 100 and the second example electrical system 100′, the power supply 110 is an alternating current (AC) power supply 110. Accordingly, when the power supply 110 is coupled to the heating arrangement 130 by the switching arrangement 120, the power supply 110 provides a periodic AC electrical power to the heating arrangement 130.

In the example of FIG. 1A, the power supply 110 is a monophase AC power supply 110. Therefore, when the power supply 110 is coupled to the heating arrangement 130 by the switching arrangement 120, the power supply 110 provides a monophase periodic AC electrical power to the heating arrangement 130. The switching arrangement 120 comprises a single semiconductor switch 120A, while the heating arrangement 130 comprises a single heating element 130A.

In the example of FIG. 1B, with respect to the second example system 100′, the power supply 110 is a polyphase AC power supply 110. Therefore, when the power supply 110 is coupled to the heating arrangement 130 by the switching arrangement 120, the power supply 110 provides a polyphase periodic AC electrical power to the heating arrangement 130. The switching arrangement 120 comprises a plurality of semiconductor switches 120A-120C. The heating arrangement 130 comprises a plurality of heating elements 130A-130C. Although the power supply 110 is shown as being a three-phase AC power supply in the example of FIG. 1B, those skilled in the art will appreciate that the principles described herein apply to similar systems provided with polyphase AC power supplies having any suitable number of phases. In the specific example of FIG. 1B, the plurality of semiconductor switches includes a first semiconductor switch 120A, a second semiconductor switch 120B, and a third semiconductor switch 120C. Further, the plurality of heating elements 130A-130C includes a first heating element 130A, a second heating element 130B, and a third heating element 130C. Each heating element 130A-130C is configured to receive a respective phase of the polyphase electrical power provided by the power supply 110 via a corresponding semiconductor switch 120A-120C of the switching arrangement 120. Each phase of the polyphase electrical power is different to each other phase of the polyphase electrical power. The supply of a respective phase of a polyphase electrical power to the heating arrangement 130 enables a smoother transfer of heat from the heating arrangement 130 to the process medium 140, because there is never any point in time, in use, when the applied voltage or the applied current within the heating arrangement 130 is zero.

In the example of FIG. 1C, the power supply 110 is a direct current (DC) power supply 110. It follows that, when the power supply 110 is coupled to the heating arrangement 130 by the switching arrangement 120, the power supply 110 provides a DC electrical power to the heating arrangement 130. Additionally, the third example system 100″ comprises a DC-DC converter 150 configured to convert a DC electric current received from the power supply 110 having a first current magnitude into a DC electric current for supply to the heating arrangement 130 via the switching arrangement 120 having a second current magnitude. The first current magnitude may generally be dissimilar to (i.e. different from) the second current magnitude. Accordingly, the DC-DC converter 150 is operable to control the magnitude of the DC electric current supplied to the heating arrangement 130 when the heating arrangement 130 is coupled to the power supply 110 by the switching arrangement 120. For this purpose, the DC-DC converter 150 may preferably comprise a chopper 150A. This may ensure particularly efficient and effective conversion of the DC currents received from the power supply 110 and provided to the heating arrangement 130, respectively, by the DC-DC converter 150. The chopper 150A may be a step-up chopper or a step-down chopper.

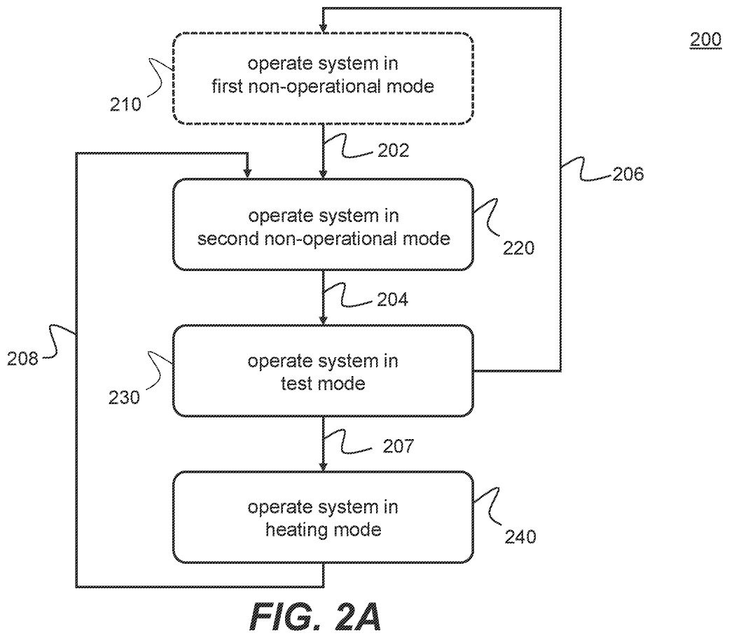

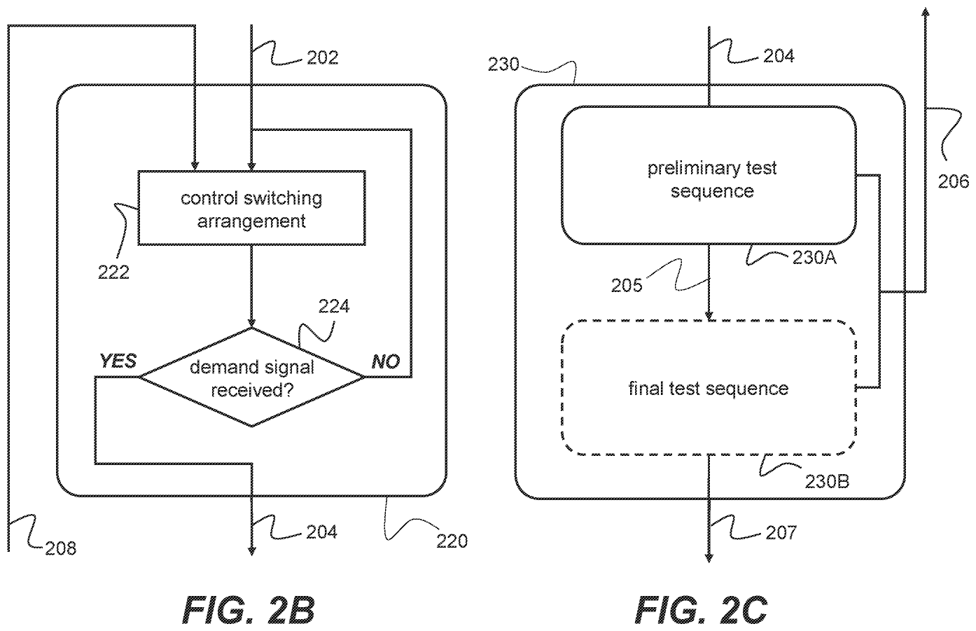

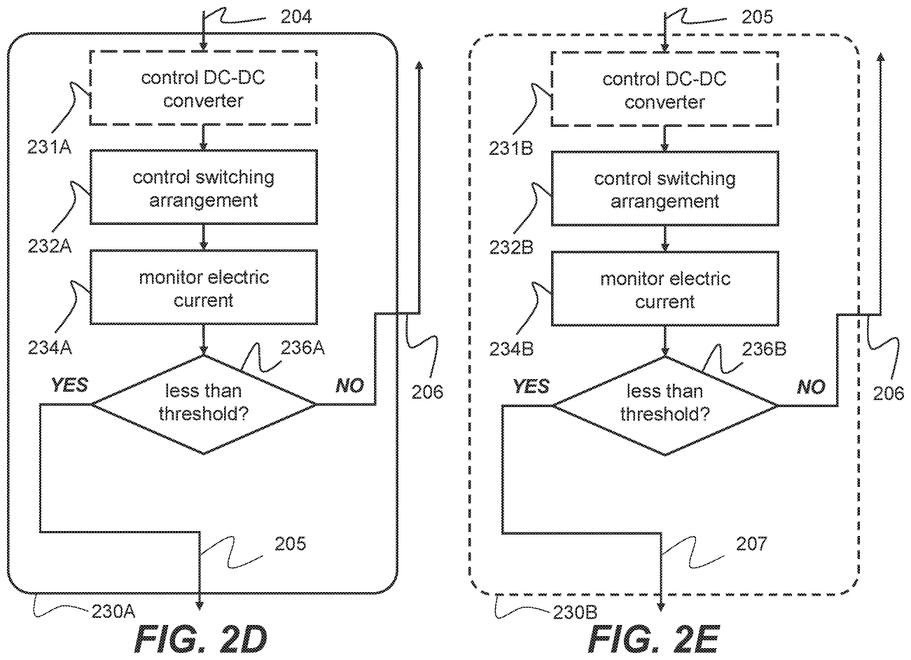

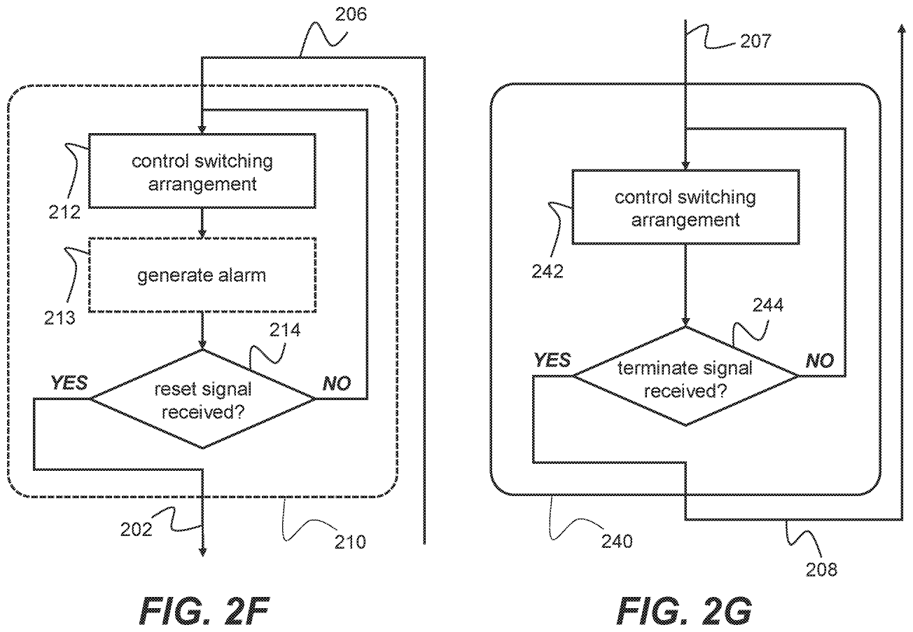

In each of the example systems 100, 100′, 100″, the current sensing arrangement 180 is adapted to monitor an electric current through the heating arrangement 130. In the second example system 100′, the current sensing arrangement 180 may be adapted to monitor an electric current through each of the heating elements 130A-130C of the heating arrangement 130. Specific types of circuitry suitable for use within the current sensing arrangement 180 for the purpose of monitoring the electric current through the heating arrangement 130 will be known to those skilled in the art. Also, in each of the example systems 100, 100′. 100″, the controller 190 is in data communication with the current sensing arrangement 180 by means of a wired and/or a wireless data connection. The controller 190 is also configured to control the switching arrangement 120 in each of the example systems 100, 100′, 100″. In the third example system 100″, the controller 190 is further configured to control the DC-DC converter 150. The controller 190 is configured to control the system 100, 100′, 100″ in accordance with the example method described below with reference to FIGS. 2A-2G.

FIG. 2A is a flowchart which shows an example method 200 of controlling a system in accordance with any of the example systems 100, 100′, 100″ described above with reference to FIGS. 1A-1C. Specific implementations of the method 200 in the context of the individual example systems of FIGS. 1A-1C are highlighted in the description below. In general terms, the method 200 comprises selectively operating the system 100, 100′, 100″ in at least a dormant mode, a test mode (at block 230) and a heating mode (at block 240). In the example of FIG. 2A, the method 200 comprises a plurality of dormant modes, the plurality of dormant modes including a first dormant mode (at block 210) and a second dormant mode (at block 220). The first dormant mode 210 may be referred to as a locked dormant mode 210, whereas the second dormant mode 220 may be referred to as a standby dormant mode. However, this disclosure is not limited to the use of two dormant modes, but also anticipates there being only a single dormant mode. If the method 200 includes a only single dormant mode, the dormant mode is the standby dormant mode 220 as shown in FIGS. 2A-2B and described herein.

The or each dormant mode 210, 220 includes controlling the switching arrangement to decouple the power supply 110 from the heating arrangement 130. As a consequence, in the or each dormant mode 210, 220, the power supply 110 does not provide electrical power to the heating arrangement 130 and therefore the heating arrangement 130 does not heat the process medium 140.

The method 200 includes selectively switching between operating the system 100, 100′ 100″ in each of the modes as illustrated by arrows 202, 204, 206, 207 and 208 extending between respective blocks 210-240. The criteria for switching between each of the modes are explained below with reference to FIGS. 2B-2G, which show the exemplary contents of blocks 210-240 in detail. Typically, the method 200 is initiated by operating the system 100, 100′, 100″ in the standby dormant mode 220.

FIG. 2B is a flowchart which shows steps of an example method for operation of a system 100, 100′, 100″ in the standby dormant mode 220 (that is, the second dormant mode 220) in detail. Operation of the system in the standby dormant mode 220 includes, at block 222, controlling the switching arrangement 120 to decouple the power supply 110 from the heating arrangement 130. As a consequence, in operation of the system in the standby dormant mode 220, the power supply 110 does not provide electrical power to the heating arrangement 130 and therefore the heating arrangement 130 does not heat the process medium 140.

Operating the system 100, 100′, 100″ in the standby dormant mode 210 further comprises determining, at block 224, whether a demand signal for heating the process medium 140 has been received. The demand signal is related to a requirement to heat the process medium 140. The demand signal may be received from, for example, a centralised control system which is in data communication with the controller 190. Otherwise, the demand signal may be received from a user-interface provided to the system according to, for example, a manual input from an operator.

In response to a determination that the demand signal has not been received at block 224, operating the system 100, 100′, 100″ in the standby dormant mode 220 includes returning to block 222, such that the switching arrangement 120 continues to be controlled to decouple the power supply 110 from the heating arrangement 130.

Conversely, in response to a determination that the demand signal has been received at block 224, operating the system 100, 100′, 100″ in the standby dormant mode 220 includes switching the system 100, 100′, 100″ from the standby dormant mode 220 to the test mode 230, as shown by arrow 204 on FIGS. 2A, 2B, 2C and 2D. In this way, the standby dormant mode 220 is responsive to a receipt of the demand signal for heating the process medium 140. In broad terms, the method 200 comprises operating the system 100, 100′, 100″ in the test mode 230 in response to the demand signal at block 224.

FIG. 2C is a flowchart which shows steps of an example method for operating the system 100, 100′, 100″ in the test mode 230 in detail. In the example of FIG. 2C, operating the system 100, 100′, 100″ in the test mode 230 includes performing a performing a plurality of test sequences. The plurality of test sequences include a preliminary test sequence (at block 230A) and a final test sequence (at block 230B). Nevertheless, in other examples in accordance with the present disclosure, operating the system in the test mode 230 may include performing only a single test sequence 230A (that is, the preliminary test sequence 230A as described herein). In such examples, the preliminary test sequence 230A may be simply referred to as the test sequence 230A. In examples comprising both the preliminary test sequence 230A and the final test sequence 230B, performance of the preliminary test sequence 230A precedes (e.g. is chronologically before) any performance of the final test sequence 230B.

FIG. 2D is a flowchart which shows steps of an example method for performing the preliminary test sequence 230A shown in FIG. 2C in detail. The preliminary test sequence includes at least process 232A, process 234A, and process 236A. In the example of FIG. 2D, the method includes 200 performing the final test sequence 230B following (i.e. chronologically after) performance of the preliminary test sequence 230A, as shown by arrow 205 on FIGS. 2C and 2D. However, if the test mode 230 only comprises the preliminary test sequence 230A, the method 200 includes performing the preliminary test sequence 230A immediately after operating the system 100, 100′, 100″ in a dormant mode (e.g. the standby dormant mode).

Process 232A includes controlling the switching arrangement 120 to couple the power supply 110 to the heating arrangement 130 for a duration of a preliminary predetermined period. The power supply 110 provides electrical power to the heating arrangement 130 for the duration of the preliminary predetermined period as a consequence of process 232A. At the end of the preliminary predetermined period, process 232A includes controlling the switching arrangement to decouple the power supply 110 from the heating arrangement 130.

Process 234A comprises monitoring an electric current through the heating arrangement 130 during (and continuously throughout) the preliminary predetermined period. If the heating arrangement 130 comprises a plurality of heating elements 130, as in the second example system 100′, process 234A may include monitoring an electric current through each of the plurality of heating elements 130A-130C. The electric current through the heating arrangement 130 is monitored using the sensing arrangement 180 as described above. Process 236A includes comparing, during the preliminary predetermined period, the monitored electric current through the heating arrangement 130 to a preliminary electric current threshold. If the test mode 230 only includes the preliminary test sequence 230A, the preliminary predetermined period may be simply referred to as the predetermined period and the preliminary electric current threshold may simply be referred to as the electric current threshold.

If the monitored electric current (through the heating arrangement 130 or each of the heating elements 130A-130C) meets or exceeds (i.e. is equal to or greater than) the preliminary electric current threshold at any point in time during the preliminary predetermined period, performing the preliminary test sequence 230A includes switching the system 100, 100′, 100″ from the test mode 230 to a dormant mode, as shown by arrow 206 on FIGS. 2A, 2C, 2D and 2E. If the system 100, 100′, 100″ is capable of operating in the locked dormant mode and the standby dormant mode, the method 200 includes switching the system 100, 100′, 100″ from operation in the test mode 230 to operation in the locked dormant mode 210. On the other hand, if the system 100, 100′, 100″ is only capable of operating in the standby dormant mode, the method 200 includes switching the system 100, 100′, 100″ from operating in the test mode 230 to operation in the standby dormant mode 220. In either case, the method 200 does not proceed to operating the system 100, 100′, 100″ in the heating mode 240 if the monitored electric current meets or exceeds the preliminary electric current threshold at any point in time during the preliminary predetermined period.

Otherwise, if the monitored electric current does not meet the preliminary electric current threshold at any point in time during the preliminary predetermined period (i.e. if the monitored current remains below the preliminary electric current threshold for the duration of the preliminary predetermined period), performing the preliminary test sequence 230A further comprises a step of switching the system 100, 100′, 100″ to performing the final test sequence 230A, as shown by arrow 205 in FIGS. 2C and 2D, or a step of switching the system 100, 100′, 100″ into the heating mode 240, as shown by arrow 207 in FIGS. 2A, 2D and 2G (depending on whether the method 200 includes performing both the final test sequence 230B and the preliminary test sequence 230A or only the preliminary test sequence 230A).

If the power supply 110 is a DC power supply 110 and the system 100″ comprises a DC-DC converter 150, as shown in the third example system 100″, the preliminary test sequence 230A is specifically implemented so as to also include a process 231A. In turn, process 231A comprises controlling the DC-DC converter 150 so as to ensure that a magnitude of the DC current of the DC electrical power provided to the heating arrangement 130 is less than a rated current of the switching arrangement 120 throughout the preliminary predetermined period. This ensures that the switching arrangement 120 is able to decouple the power supply 110 from the heating arrangement 130 at the end of the preliminary predetermined period without suffering damage or a failure. This may be of particular importance because the switching arrangement 120 comprises at least one semiconductor switch 120A. As mentioned above, the rated current of semiconductor switches may generally be lower than the rated current of conventional types of switches (e.g. non-semiconductor switches). Therefore, controlling the DC-DC converter 150 in this manner may reduce a mean time between failures and thereby extend a service lifetime of the system 100″.

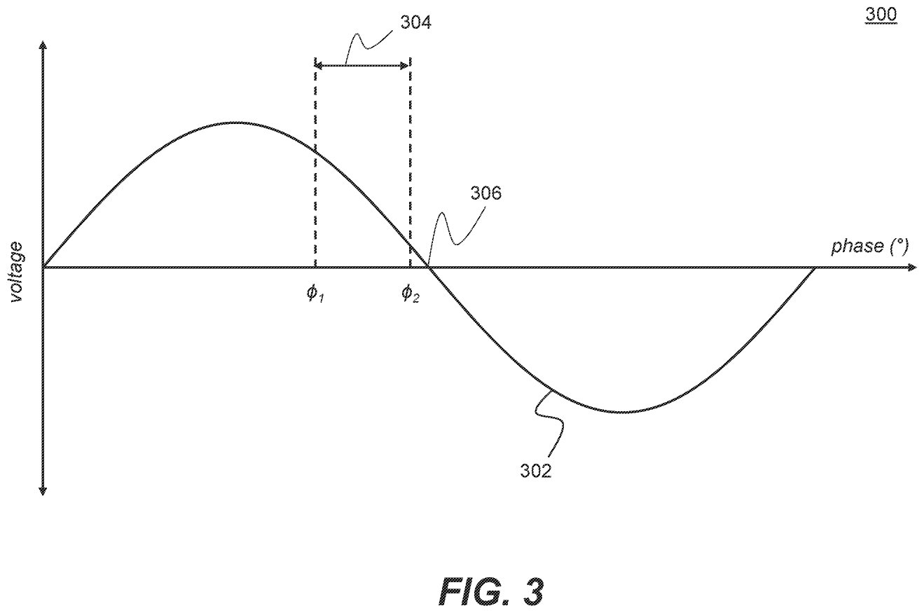

If the power supply 110 is an AC power supply 110, as shown in the first example system 100 and the second example system 100′, the preliminary test sequence 230A may be implemented in a variety of ways. Specific example implementations of the preliminary test sequence 230A for use in the context of a system 100, 100′ comprising an AC power supply are explained below with reference to FIG. 3, which is an annotated graph 300 which shows a simplified profile 302 of the voltage of one phase of the periodic AC electrical power provided by the AC power supply 110 on the y-axis against the phase (in degrees, °) of the periodic AC electrical power on the x-axis. The simplified profile 302 shown in FIG. 3 is intended to aid understanding of the test mode 230 described herein, and is not intended to closely correspond to a true profile of one phase AC electrical power provided by the AC power supply 110 in typical operation.

In broad terms, the duration of the preliminary predetermined period is intentionally very short. This ensures that, even if a fault is present within the heating arrangement 130, the supply of electrical power to the heating arrangement 130 for the preliminary predetermined period is unlikely to result in (further) damage to the system 100, 100′ and/or significant unintended conduction of electric current to components outside of the system. However, the supply of electrical power to the heating arrangement 130 for the preliminary predetermined period may enable a fault which is present within the heating arrangement 130 to be detected before the system 100, 100′, 100″ is operated in the heating mode 240 (or switched into the final test sequence 230B, if applicable). In addition, the supply of electrical power to the heating arrangement 130 for the preliminary predetermined period may promote at least partial drying of the heating element(s) 130A-130B of the heating arrangement 130 if fluid (e.g. process fluid 140) has come into proximity of or into contact with the heating arrangement 130 due to ingression of fluid into the heating arrangement 130. For comparison, methods not in accordance with the present disclosure may proceed directly from, for example, the standby dormant mode 220 to the heating mode 240. However, if fluid has come into proximity of or into contact with the heating arrangement 130, moving directly to coupling of the power supply 110 to the heating arrangement 130 at block 242 in response to receipt of the demand signal at block 224 may result in damage to the system 100, 100′ and/or significant unintended conduction of electric current to components outside of the system before the heating element(s) 130A-130B of the heating arrangement 130 were adequately dried.

More specifically, the duration of the preliminary predetermined period may be defined according to the properties of the periodic AC electrical power provided by the AC power supply 110 in use. The periodic AC electrical power provided by the AC power supply 110, in operation, has a characteristic time period (e.g. the AC time period) which is the mathematical reciprocal of a characteristic frequency (e.g. the AC frequency). The duration of the preliminary predetermined period may be no greater than 25% of a duration of the characteristic time period of the periodic AC electrical power. In general, the AC electrical power may have a characteristic frequency of no less than 50 Hz, and so the characteristic time period of the periodic AC electrical power may be no greater than 20 milliseconds. Accordingly, the duration of the preliminary predetermined period may be no greater than 5 milliseconds. Preferably, the duration of the preliminary predetermined period may be no greater than 10% of a duration of the characteristic time period of the periodic AC electrical power, such that the duration of the preliminary predetermined period is no greater than 2 milliseconds. Application of these criteria ensures that the duration of the preliminary predetermined period is defined so as to ensure that the supply of electrical power to the heating arrangement 130 for the preliminary predetermined period is unlikely to result in (further) damage to the system 100, 100′ and/or significant unintended conduction of electric current to components outside of the system.

Additionally or alternatively, the preliminary predetermined period may be defined according to a phase angle range 304 of the periodic AC electrical power provided by the AC power supply 110, as shown on FIG. 3. The phase angle range 304 is defined between a first phase angle ϕ₁ of the periodic AC electrical power 302 and a second phase angle ϕ₂ of the periodic AC electrical power 302. This means that the AC power supply 110 is coupled to the heating arrangement 130 at the first phase angle ϕ₁ and decoupled from the heating arrangement 130 at the second phase angle ϕ₂.

Both the first phase angle ϕ₁ and the second phase angle ϕ₂ are relatively close to a zero-crossing phase angle 306 (i.e. the zero-crossing point) of the periodic AC electrical power 302, with the second phase angle ϕ₂ being relatively closer to the zero-crossing phase angle 306 than the first phase angle ϕ₁. In some examples, the second phase angle ϕ₂ may be at the zero-crossing phase angle 306. This timing of the selective coupling and decoupling of the AC supply 110 to and from the heating arrangement 130 ensures that the voltage applied to the heating arrangement during the preliminary predetermined period is significantly less than the peak voltage (that is, the maximum amplitude) of the periodic AC electrical power 302. This is generally associated with improved safety during the test mode 230, and may also ensure that the current through the heating arrangement 130 is less than the rated current of the switching arrangement 120 throughout the preliminary predetermined period.

The second phase angle ϕ₂ of the periodic AC electrical power 302 may be between: 10 degrees less than the zero-crossing phase angle 306 and the zero-crossing phase angle 306 of the periodic AC electrical power 302. Preferably, the second phase angle ϕ₂ of the periodic AC electrical power 302 may be between: 5 degrees less than the zero-crossing phase angle 306 and the zero-crossing phase angle 306 of the periodic AC electrical power 302. More preferably, the second phase angle ϕ₂ of the periodic AC electrical power 302 may be between: 2 degrees less than the zero-crossing phase angle 306 and the zero-crossing phase angle 306 of the periodic AC electrical power 302. It may even be that the phase angle ϕ₂ of the periodic AC electrical power 302 is approximately equal to the zero-crossing phase angle 306 of the periodic AC electrical power 302.

The first phase angle ϕ₁ of the periodic AC electrical power 302 may be between 1 and 20 degrees less than the second phase angle ϕ₂ of the periodic AC electrical power 302, such that the phase angle range 304 is between 1 and 20 degrees. Preferably, the first phase angle ϕ₁ of the periodic AC electrical power 302 may be between 1 and 10 degrees less than the second phase angle ϕ₂ of the periodic AC electrical power 302, such that the phase angle range 304 is between 1 and 10 degrees. More preferably, the first phase angle ϕ₁ of the periodic AC electrical power 302 may be between 1 and 5 degrees less than the second phase angle ϕ₂ of the periodic AC electrical power 302, such that the phase angle range 304 is between 1 and 5 degrees.

Specification of the predetermined period in accordance with the phase angle range criteria 304 described above ensures that the voltage of the periodic AC electrical power is decaying throughout the phase angle range 304 and therefore the preliminary predetermined period. Advantageously, even if the coupling and/or decoupling function provided by the switching arrangement 120 is delayed (i.e. is associated with a lag-time) in use, the voltage of the periodic AC electrical power is likely to remain significantly lower than the peak voltage (that is, the maximum amplitude) of the periodic AC electrical power 302 throughout the preliminary predetermined period. As discussed above, this is associated with improved safety of the system 100, 100′ and may also help ensure that the current through the heating arrangement 130 is less than the rated current of the switching arrangement 120 throughout the preliminary predetermined period.

FIG. 2E is a flowchart which shows an example final test sequence 230B shown in FIG. 2C in detail. The final test sequence 230B is generally similar to the preliminary test sequence 230A, with like reference numerals differentiated by the suffixes A and B indicating similar features.

Process 232B includes controlling the switching arrangement 120 to couple the power supply 110 to the heating arrangement 130 for a duration of a final predetermined period. Like the duration of the preliminary predetermined period, the duration of the final predetermined period is intentionally very short. However, the duration of the final predetermined period and the duration of the preliminary predetermined period may be dissimilar, as explained in further detail below.

Process 234B comprises monitoring an electric current through the heating arrangement 130 during (and continuously throughout) the final predetermined period using the sensing arrangement 180. Process 236B includes comparing, during the final predetermined period, the monitored electric current through the heating arrangement 130 to a final electric current threshold. The magnitude of the final electric current threshold and the magnitude of the preliminary electric current threshold are different for the reasoning set out further below.

If the monitored electric current meets or exceeds the final electric current threshold at any point in time during the final predetermined period, performing the final test sequence 230B includes switching the system 100, 100′, 100″ from the test mode 230 to a dormant mode, as shown by arrow 206 on FIGS. 2A, 2C, 2D and 2E. In a similar way to the procedure described above in respect of the final test sequence 230A, depending on whether the system 100, 100′, 100″ is capable of operating in the locked dormant mode and the standby dormant mode, the method 200 either includes switching the system 100, 100′, 100″ from operation in the test mode 230 to operation in the locked dormant mode 210 or to operation in the standby dormant mode 220.

On the other hand, if the monitored electric current does not meet the final electric current threshold at any point in time during the final predetermined period (i.e. if the monitored electric current remains below the final electric current threshold for the duration of the final predetermined period), performing the final test sequence 230B includes a step of switching the system 100, 100′, 100″ into the heating mode 240, as shown by arrow 207 in FIGS. 2A, 2C and 2G.

The or each electric current threshold is selected to correspond to an expected upper limit for the magnitude of the electric current through the heating arrangement 130 during the respective predetermined period if the heating arrangement 130 is not in a fault condition. If the monitored electric current meets or exceeds the relevant electric current threshold at any point during the respective predetermined period, this may generally be indicative of the presence of a fault within the heating arrangement 130 or indicative of the heating element(s) 130A-130B of the heating arrangement 130 having being wetted by, for example, the process fluid 140. For instance, it may be that a short-circuit fault within the heating arrangement 130 has developed since the system 100, 100′, 100″ was last operated, which causes the monitored electric current to be higher than expected during performance of the preliminary test sequence 230A or the final test sequence 230B. The method 200 therefore takes action to prevent the system 100, 100, 100″ from being operated in the heating mode 240 in response to the monitored electrical current meeting or exceeding the relevant electric current threshold at any point during the respective predetermined period. The method 200 switches the system 100, 100′, 100″ into a dormant mode, which may be the locked dormant mode 210 or the standby dormant mode 220, as discussed above.

If operating the system 100, 100′. 100″ in the test mode 230 includes performing the final test sequence 230B, the final and preliminary electric current thresholds are dissimilar. Because the final predetermined period is longer than the preliminary predetermined period and/or the magnitude of the DC current through the heating arrangement throughout the final predetermined period is greater than the magnitude of the DC current through the heating arrangement throughout the preliminary predetermined period, the final electric current threshold is greater than the preliminary electric current threshold.

In particular, if the power supply 110 is an AC power supply 110 and the preliminary predetermined period is defined by a phase angle range 304 as discussed above with reference to FIG. 3, the final predetermined period may be similarly defined by a phase angle range 304. However, the final predetermined period may be defined by a larger phase angle range than the preliminary predetermined period. For instance, if the final predetermined period is defined by a phase angle range 304 of approximately 10 degrees, the preliminary predetermined period may be defined by a phase angle range 304 of approximately 5 degrees. The first phase angle ϕ₁ and the second phase angle ϕ₂ may be determined accordingly to appropriately define each of the preliminary predetermined period and the final predetermined period.

Further, if the power supply 110 is an AC power supply 110, the duration of the final predetermined period is longer than the duration of the preliminary predetermined period. As a particular example, if the final predetermined period is defined by a phase angle range 304 as discussed in the above paragraph, the first phase angle ϕ₁ of the phase angle range 304 which defines the preliminary predetermined period may be closer to the zero-crossing phase angle 306 than the first phase angle ϕ₁ of the phase angle range 304 which defines the final predetermined period. In addition, the second phase angle ϕ₂ of the phase angle range 304 which defines the preliminary predetermined period may be chosen so that the phase angle range 304 which defines the preliminary predetermined period is equal to or smaller than the phase angle range 304 which defines the final predetermined period. This results in the phase angle range 304 which defines the final predetermined period being larger than the phase angle range 304 which defines the preliminary predetermined period.

This specification of the timing of the selective coupling and decoupling of the AC supply 110 to and from the heating arrangement 130 in the respective test sequences 230A, 230B ensures that the voltage applied to the heating arrangement 130 during the preliminary predetermined period is always less than the voltage applied to the heating arrangement 130 during the final predetermined period. In turn, this may facilitate safer performance of the test sequence 230 and/or better drying of the heating arrangement 130 during the test sequence 230.

If the power supply 110 is a DC power supply 110 and the system 100″ comprises a DC-DC converter 150, as shown in the third example system 100″, the final test sequence 230B is specifically implemented so as to also include a process 231B. Process 231B is generally comparable to process 231A in that it similarly comprises controlling the DC-DC converter 150 so as to ensure that a magnitude of the DC current of the DC electrical power provided to the heating arrangement 130 is less than a rated current of the switching arrangement 120 throughout the final predetermined period, for similar reasoning as given above in reference to process 231A.

However, the magnitude of the electric current through the heating arrangement 130 during (and continuously throughout) the preliminary predetermined period is less than the magnitude of the electric current through the heating arrangement 130 during (and continuously throughout) the final predetermined period. The DC-DC converter 150 may be specifically controlled by the controller 190 to this end. This may facilitate effective drying of the heating element(s) 130A-130C during the final test sequence 230B prior to operation of the system 100, 100′, 100″ in the heating mode 240.

Performance of both the final test sequence 2308 and the preliminary test sequence 230A in the test mode 230 may allow for incremental drying of the heating arrangement 130 during the method. Performance of the final test sequence 230B may allow the heating element(s) of the heating arrangement 130 to be (further) dried by evaporation prior to operation of the system 100, 100′, 100″ in the heating mode 240 in addition to any partial drying in the preliminary test sequence 230A. If the heating element(s) of the heating arrangement 130 had not been dried as a result of performance of the final test sequence 230B, the wet condition of the heating arrangement 130 may have resulted in adverse electrical effects (e.g. significant unintended conduction of electric current to components outside of the system 100, 100′. 100″) if the system 100, 100′. 100″ were operated in the heating mode 240. Therefore, the performance of both test sequences enables more reliable and effective operation of the system 100, 100′. 100″. Moreover, the heating arrangement 130 being in a fault condition may be detected in the preliminary test sequence 230A (which is at a lower voltage) and the system 100, 100′ may be moved into a dormant mode without a need to execute the final test sequence 230B (which is at a higher voltage). This is associated with safer operation of the system 100, 100′, 100″.

FIG. 2F is a flowchart which shows steps in an example method for operating the system 100, 100′, 100″ in the locked dormant mode 210 (that is, the first dormant mode 210) in detail. Like operating the system 100, 100′, 100″ in the standby dormant mode 220, operating the system 100, 100′, 100″ in the locked dormant mode includes, at block 212, controlling the switching arrangement 120 to decouple the power supply 110 from the heating arrangement 130. As a consequence, when the system 100, 100′, 100″ is operated in the locked dormant mode 210, the power supply 110 does not provide electrical power to the heating arrangement 130 and therefore the heating arrangement 130 does not heat the process medium 140. In contrast to when the system 100, 100′, 100″ is operating in the standby dormant mode 220, when operated in the locked dormant mode 210, the system 100, 100′, 100″ is not responsive to a receipt of the demand signal for heating the process medium 140. In other words, operating the system 100, 100′, 100″ in the locked dormant mode includes continuing to operate the system 100, 100′, 100″ in the first non-operation mode 210 in response to the demand signal.

In further contrast to operating the system 100, 100′, 100″ the second dormant mode 220, the operating the system 100, 100′. 100″ in the locked dormant mode 210 comprises determining, at block 214, whether a reset signal has been received. The reset signal may be received from a user-interface provided to the system according to a manual input from an operator. For instance, after performing maintenance on the heating arrangement 130 so as to rectify any identified faults, the operator may manipulate the user-interface and thereby cause the reset signal to be provided to the controller 190. In response to a determination that the reset signal has not been received at block 214, operating the system in the locked dormant mode 210 includes returning to block 212, such that the switching arrangement 120 continues to be controlled to decouple the power supply 110 from the heating arrangement 130. Conversely, in response to a determination that the reset signal has been received at block 214, operating the system 100, 100′, 100″ in the locked dormant mode 210 includes switching the system 100, 100′, 100″ from operating in the locked dormant mode 210 to operation in the second dormant mode 220, as shown by arrow 202 on FIGS. 2A, 2B and 2F.

Operating the system 100, 100′, 100″ in the locked dormant mode 210 may also include, at block 213, generating an alarm signal indicative of a fault within the heating arrangement 130. The alarm signal may generally be intended to alert an operator or a maintenance system to the presence of a fault within the heating arrangement 130. The alarm signal may be provided to, for example, a user-interface of the system, a remote monitoring device, and/or a centralised control system by the controller 190. In particular, the alarm signal may result in the activation of an audible, visual and/or tactile alert at the user-interface, the remote monitoring device, and/or the centralised control system. Generating the alarm signal may prompt an operator or maintenance system to perform any required maintenance on the heating arrangement 130, such as replacing or repairing a seal around the heating arrangement 130 and/or the individual heating elements 130A-130C, replacing or repairing the individual heating element(s) 130A-130C of the heating arrangement 130, and/or replacing the entire heating arrangement 130. Because operating the system 100, 100′, 100″ in the locked dormant mode 210 includes decoupling the heating arrangement 130 from the power supply 110, maintenance may be safely executed while the system 100, 100′ 100″ is operated in the locked dormant mode 210. Subsequently, the operator may cause the reset signal to be provided to the controller 190 as described above, which results in the system 100, 100′ 100″ being switched into the second dormant mode 220 (that is, the standby dormant mode). Accordingly, the system 100, 100′, 100′ may then be switched into operating in the test mode 230 in response to the receipt of the demand signal for heating the process medium 140 and, if appropriate, subsequently safely switched into operating in the heating mode 240.

FIG. 2G is a flowchart which shows steps of an example method for operating the system 100, 100′, 100″ in the heating mode 240 in detail. Operating the system 100, 100′, 100″ heating mode includes, at block 242, controlling the switching arrangement 120 to couple the power supply 110 to the heating arrangement 130. Therefore, when the system 100, 100′, 100″ is operated in the heating mode 240, the power supply 110 provides electrical power to the heating arrangement 130 and therefore the heating arrangement 130 heats the process medium 140. Heating of the process medium 140 may be to achieve a target temperature, and/or to maintain the process medium 140 at the target temperature.

Operating the system 100, 100′, 100″ in the heating mode 210 comprises determining, at block 244, whether a terminate signal for ending heating of the process medium 140 has been received. The terminate signal may be received from, for example, the centralised control system which is in data communication with the controller 190. Otherwise, the terminate signal may be received from a user-interface provided to the system according to, for example, a manual input from an operator. In response to a determination that the terminate signal has not been received at block 244, operating the system 100, 100′. 100″ in the heating mode 240 includes returning to block 242, such that the switching arrangement 120 continues to be controlled so as to couple the power supply 110 to the heating arrangement 130. Conversely, in response to a determination that the terminate signal has been received at block 244, operating the system 100, 100′, 100″ in the heating mode 240 includes switching the system 100, 100′, 100″ from the heating mode 240 to the standby dormant mode 220, as shown by arrow 208 on FIGS. 2A, 2B and 2G.

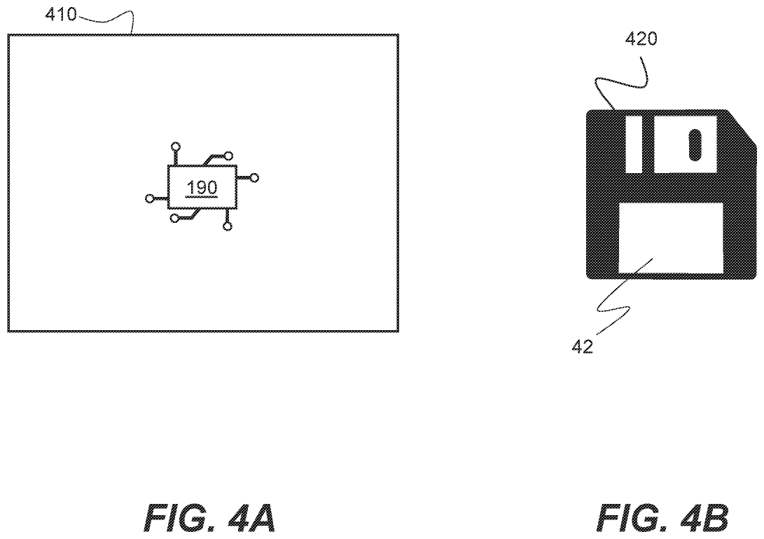

FIG. 4A highly schematically shows a data processing apparatus 410 comprising a controller 190 adapted to perform the method described above with reference to FIG. 2A (and FIGS. 2B-2G). The controller 190 may have any of the features of the controller 190 described above with respect to FIGS. 1A-1C. FIG. 4B symbolically shows a machine-readable medium 420 having stored thereon a software program 42 comprising instructions which, when executed by a controller 190 (e.g. the controller 190 provided to the example systems 100, 100′, 100″ described above with reference to FIGS. 1A-1C), cause the controller 190 to execute the method 200 described above with reference to FIG. 2A (and FIGS. 2B-2G).

The controller 190 described herein may comprise a processor. The controller or processor may comprise: at least one application specific integrated circuit (ASIC); and/or at least one field programmable gate array (FPGA); and/or single or mufti-processor architectures; and/or sequential (Von Neumann)/parallel architectures; and/or at least one programmable logic controllers (PLCs); and/or at least one microprocessor; and/or at least one microcontroller; and/or a central processing unit (CPU), to the stated functions for which the controller or processor is configured.

Except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

1. A method of controlling a system including a heating arrangement for heating a process medium, a current sensing arrangement, and a switching arrangement configured to selectively couple a power supply to the heating arrangement, the switching arrangement comprising at least one semiconductor switch, the method comprising:
in response to a demand signal for starting heating of the process medium, operating the system in a test mode, wherein operating the system in the test mode includes performing a test sequence comprising:
controlling the switching arrangement to couple the power supply to the heating arrangement for a predetermined period;
monitoring an electric current through the heating arrangement during the predetermined period using the current sensing arrangement;
comparing the monitored electric current to an electric current threshold during the predetermined period; and
switching the system from operation in the test mode to operation in a dormant mode if the monitored electric current meets or exceeds the electric current threshold during the predetermined period, wherein:
operation of the system in the dormant mode includes controlling the switching arrangement to decouple the power supply from the heating arrangement.

2. The method of claim 1, wherein:
performing the test sequence further comprises switching the system from operation in the test mode to operation in a heating mode if the monitored electric current does not meet the current threshold during the predetermined period, wherein:
operation of the system in the heating mode includes controlling the switching arrangement to couple the power supply to the heating arrangement for heating the process medium.

3. The method of claim 2, wherein:
operation of the system in the heating mode includes, in response to a terminate signal for ending heating of the process medium, switching the system from operation in the heating mode to operation in the dormant mode.

4. The method of claim 1, wherein, when coupled to the heating arrangement, the power supply provides a periodic AC electrical power to the heating arrangement, and wherein a duration of the predetermined period is no greater than 25% of a duration of a characteristic time period of the periodic AC electrical power.

5. The method of claim 4, wherein the duration of the characteristic time period of the periodic AC electrical power is no greater than 20 milliseconds.

6. The method of claim 1, wherein, when coupled to the heating arrangement, the power supply provides a periodic AC electrical power to the heating arrangement, wherein the predetermined period is defined according to a phase angle range of the periodic AC electrical power, the phase angle range being defined between a first phase angle of the periodic AC electrical power and a second phase angle of the periodic AC electrical power, and wherein:
the second phase angle of the periodic AC electrical power is between:
10 degrees less than a zero-crossing phase angle of the alternating current electrical power; and
the zero-crossing phase angle of the alternating current electrical power; and the first phase angle of the AC electrical power is between 1 and 20 degrees less than the second phase angle of the AC electrical power.

7. The method of claim 1, wherein:
the test sequence is a final test sequence, the electric current threshold is a final electric current threshold and the predetermined period is a final predetermined period;
operation of system in the test mode includes performing a preliminary test sequence preceding the final test sequence; and
performing the preliminary test sequence comprises:
controlling the switching arrangement to couple the power supply to the heating arrangement for a preliminary predetermined period;
monitoring an electric current passing through the heating arrangement during the preliminary predetermined period using the current sensing arrangement;
comparing the monitored electric current to a preliminary electric current threshold during the preliminary predetermined period,
switching the system from performing the preliminary test sequence to the final test sequence if the monitored electric current does not meet the preliminary current threshold during the preliminary predetermined period, and
switching the system from operation in the test mode to operation in the dormant mode if the monitored electric current meets or exceeds the preliminary electric current threshold during the preliminary predetermined period.

8. The method of claim 7, wherein, when coupled to the heating arrangement, the power supply provides a periodic AC electrical power to the heating arrangement, and wherein a duration of the predetermined period is no greater than 25% of a duration of a characteristic time period of the periodic AC electrical power, and wherein a duration of the final predetermined period is greater than a duration of the preliminary predetermined period.

9. The method of claim 8, wherein each of the final predetermined period and the preliminary predetermined period is defined according to a phase angle range of the periodic AC electrical power, each phase angle range being defined between a first phase angle of the periodic AC electrical power and a second phase angle of the periodic AC electrical power, and wherein the first phase angle which defines the preliminary predetermined period is closer to the zero-crossing phase angle of the periodic AC electrical power than the first phase angle which defines the final predetermined period.

10. The method of claim 1, wherein, when coupled to the heating arrangement, the power supply provides a DC electrical power to the heating arrangement, and wherein the system comprises a DC-DC converter, and wherein:
performing the test sequence includes controlling the DC-DC converter to ensure that a magnitude of a DC current of the DC electrical power provided to the heating arrangement is less than a rated current of the switching arrangement throughout the predetermined period.

11. The method of claim 10, wherein:
the test sequence is a final test sequence, the electric current threshold is a final electric current threshold and the predetermined period is a final predetermined period;
operation of system in the test mode includes performing a preliminary test sequence preceding the final test sequence; and
performing the preliminary test sequence comprises;
controlling the switching arrangement to couple the power supply to the heating arrangement for a preliminary predetermined period;
monitoring an electric current passing through the heating arrangement during the preliminary predetermined period using the current sensing arrangement;
comparing the monitored electric current to a preliminary electric current threshold during the preliminary predetermined period,
switching the system from performing the preliminary test sequence to the final test sequence if the monitored electric current does not meet the preliminary current threshold during the preliminary predetermined period, and
switching the system from operation in the test mode to operation in the dormant mode if the monitored electric current meets or exceeds the preliminary electric current threshold during the preliminary predetermined period,
wherein performing the preliminary test sequence includes controlling the DC-DC converter to ensure that a magnitude of a DC current of the DC electrical power provided to the heating arrangement is less than a rated current of the switching arrangement throughout the preliminary predetermined period; and
the magnitude of the DC current through the heating arrangement throughout the preliminary predetermined period is less than the magnitude of the DC current through the heating arrangement throughout the final predetermined period.

12. The method of claim 11, wherein the DC-DC converter includes a chopper.

13. The method of claim 1, wherein the at least one semiconductor switch is a transistor or a thyristor.

14. The method of claim 1, wherein the at least one semiconductor switch is selected from a group consisting of: a field-effect transistor, a gate turn-off thyristor, integrated-gate bipolar transistor, an integrated gate-commutated thyristor, and an injection-enhanced gate transistor.

15. The method of claim 1, wherein:
operation of the system in the test mode includes switching the system from operation in the test mode to operation of the system in a first dormant mode if the monitored electric current meets or exceeds the electric current threshold during the predetermined period,
operation of the system in the first dormant mode includes:
controlling the switching arrangement to decouple the power supply from the heating arrangement;
in response to the demand signal for starting heating of the process medium, continuing to operate the system in the first dormant mode; and
in response to a reset signal, switching the system from operation in the first dormant mode to operation in a second dormant mode, and
operation of the system in the second dormant mode includes:
controlling the switching arrangement to decouple the power supply from the heating arrangement;
in response to the demand signal for starting heating of the process medium, switching the system from the second dormant mode to the test mode.

16. The method of claim 15, wherein operation of the system in the first dormant mode includes generating an alarm indicative of a fault associated with the heating arrangement.

17. The method of claim 1, wherein, when coupled to the heating arrangement, the power supply provides a polyphase periodic AC electrical power to the heating arrangement, and wherein the heating arrangement comprises a plurality of heating elements, each heating element being configured to receive a respective phase of the polyphase periodic AC electrical power from the power supply via the switching arrangement.

18. A data processing apparatus comprising a controller adapted to perform the method of claim 1.

19. A system comprising:
a heating arrangement for heating a process medium;
a switching arrangement configured to selectively couple a power supply to the heating arrangement, the switching arrangement comprising at least one semiconductor switch;
a current sensing arrangement; and
a controller configured to control the system in accordance with the method of claim 1.

20. A machine-readable storage medium having stored thereon instructions which, when executed by a controller, cause the controller to carry out the method of claim 1.
